(19) United States
(12) Patent Application Publication
(10) Pub. No.: US 2006/0007487 A1
(43) Pub. Date: Jan. 12, 2006

(54) Printer, control method, program and recording medium

(75) Inventor: Takashi Okazawa, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/176,360

(22) Filed: Jul. 8, 2005

(30) Foreign Application Priority Data
Jul. 9, 2004 (JP) 2004-203397

(51) Int. Cl. G06F 15/00

(52) U.S. Cl. 358/1.15

(57) ABSTRACT

With the conventional art, when the time of a host computer is not correct, the incorrect time is set to a printer, a scheme for setting the more correct time is desired. The invention provides a scheme for determining the priority of the time inputted from outside a plurality of time originators, and setting the time of which the priority is determined to be higher by the determination.

### BACKGROUND OF THE INVENTION

1. Field of the Invention

The present invention relates to a scheme of setting the time for a printer.

2. Related Background Art

Conventionally, the printer that uses E-mail for various notifications to the outside or the printer that records the log with time appended is well known.

The apparatus having a printer function that is connected to the network has usually a simple clock function installed, because the clock function is indispensable. However, the apparatus having the printer function of low price often mounts a clock not backed up with the battery while the power is turned off to reduce the costs. In this case, though the almost correct time is obtained since the clock is put right till the power is turned off, the correct time will not be obtained once the power is turned off, as long as the clock is put right again.

And as a method for the apparatus connected to the network to acquire the time, a method for notifying the time from a host computer at higher rank has been proposed. For instance, Japanese Patent Application Laid-Open No. 2001-105694 and Japanese Patent Application Laid-Open No. 2003-260851 are well known.

A technology as disclosed in Japanese Patent Application Laid-Open No. 2001-105694 involves setting the time of an internal clock of the apparatus having the printer function, using the time included in registered data from the host computer.

Moreover, a technology as disclosed in Japanese Patent Application Laid-Open No. 2003-260851 involves setting the time of the host computer that firstly sent the print data to an internal clock of the printer by including the time information in the print data.

However, according to the conventional technologies, when the time of the host computer is not accurate, the inaccurate time may be set to the printer, whereby it is desired to provide a scheme for setting more accurate time.

Moreover, if the printer itself acquires the time from a time server, and is set to the acquired time, the accurate time can be set to the printer. However, there was a problem that the time could not be set when the time server was down by some causes.

Moreover, it is possible to prevent the situation where the time itself cannot be set when the time server is down by some causes.

### SUMMARY OF THE INVENTION

Accordingly, the present invention is conceived as a response to the above-described-disadvantages of the conventional art.

According to one aspect of the present invention, preferably, there is provided an image forming apparatus comprising determination device for determining the priority of the time externally input, and setting device for setting the time based on the time of which the priority is determined to be higher by the determination device.

With the above configuration, when the time of the host computer is wrong or incorrect, the wrong or incorrect time is prevented from being set to the printer, whereby the more correct time is set up.

Other features and advantages of the present invention will be apparent from the following description taken in conjunction with the accompanying drawings, in which like reference characters designate the same or similar parts throughout the figures there.

### BRIEF DESCRIPTION OF THE DRAWINGS

FIG. 1 is a diagram showing the system configuration of a network architecture comprising a data processing apparatus according to an embodiment of the present invention;

FIG. 2 is a block diagram showing the configuration of a printing system, and mainly showing a host computer according to the embodiment of the invention;

FIG. 3 is a block diagram showing the functional configuration of the printing system according to the embodiment of the invention;

FIG. 4 is a flowchart showing a time setting processing routine of the invention in a program for transmitting the time information to the printer in the host computer;

FIG. 5 is a flowchart showing a time setting processing routine of the invention in the printer;

FIG. 6 is a flowchart showing the time setting processing routine of the invention in the printer;

FIG. 7 is a flowchart showing an error log creation processing routine of the invention in the printer;

FIG. 8 is a flowchart showing a log acquisition command processing routine of the invention in the printer;

FIG. 9 is an example of displaying the job log information;

FIG. 10 is an example of a user interface screen for setting the device time;

FIG. 11 is an example of a user interface screen for designating a server that sets up the device time; and

FIG. 12 is a display example of the error log information.

### DETAILED DESCRIPTION OF THE PREFERRED EMBODIMENTS

A preferred embodiment of the present invention will now be described in detail with reference to the drawings. It should be noted that the relative arrangement of the components, the numerical expressions and numerical values set forth in these embodiments do not limit the scope of the present invention unless it is specifically stated otherwise.

The preferred embodiments of the present invention will be described below with reference to the drawing.

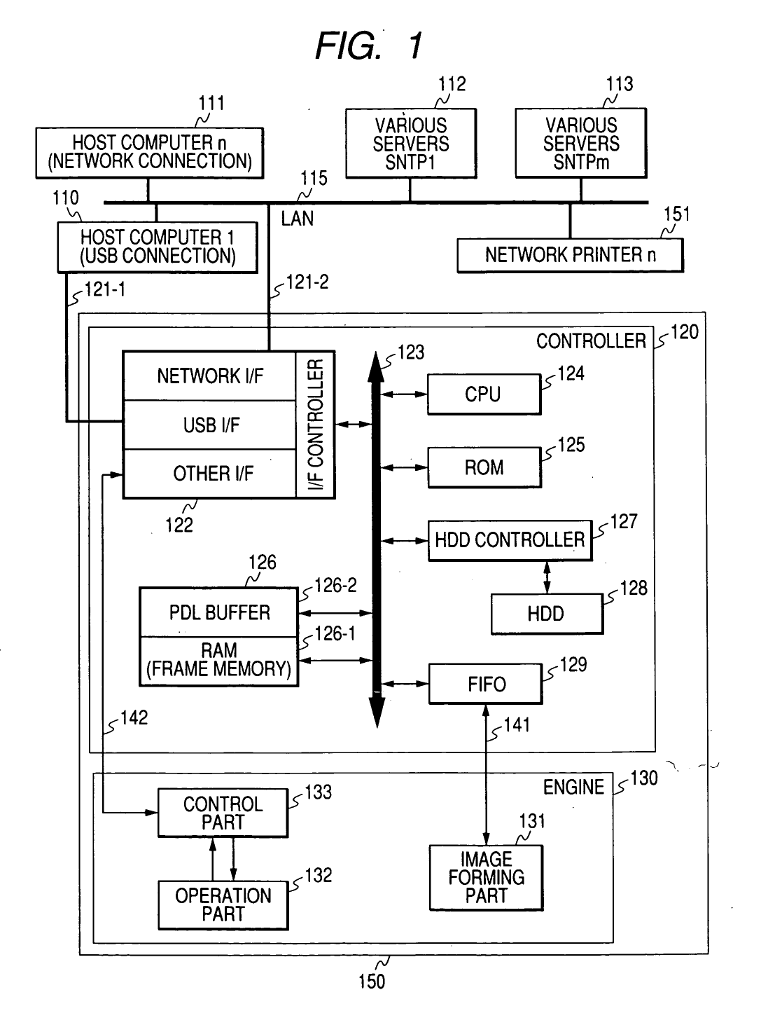

FIG. 1 is a block diagram showing the configuration of an image processing system having an image processing apparatus according to a first embodiment of the present invention.

The image processing system of this embodiment is constituted of an image forming apparatus 150 comprising a plurality of host computers 110/111 connected to a network, various kinds of servers 112/113, a controller (image processing apparatus) 120 for performing a predetermined image processing for image data transmitted through an interface (local I/F 121-1 or network I/F 121-2) from the host computers or the servers, and an engine 130 such as a copying machine connected to the controller 120 to print out the digital image in color or gray scale.

The controller 120 has an external interface 121 connected via an interface 121 (121-1, 121-2) to the host computer 110, the external interface being connected to a CPU bus 123. The CPU bus has connected to a CPU 124 for controlling the operation of the whole apparatus, a ROM 125 storing a control program (including a flow as will be described later), a RAM 126 (126-1, 126-2) for use as a work area, an HDD controller 127 for controlling an internal hard disk (HDD) 128 storing the font data, temporary stored data, and print image data, and an FIFO 129. Herein, the RAM comprises a frame memory 126-1 storing the raster image data, and a PDL buffer 126-2 holding the PDL image data. The raster image data is not stored in the frame memory 126-1, but may be stored in the internal HDD 128. Also, plural pieces of image data stored in the internal HDD 128 may be printed out in the order according to an edit mode designated on an operation part 132 of the printer.

In this controller 120, the PDL (Page Description Language) image data transmitted through the local interface 121-1 or the network interface 121-2 from the host computer 110 is once stored via the CPU bus 123 in a PDL buffer 126-2. The CPU 124 expands the PDL image data saved in the PDL buffer 126-2 into raster image data, using the font data in the ROM 125 or internal HDD 128, and writes it into the frame memory 126-1.

From this controller 120, the raster image data is sent via the CPU bus 123 and the FIFO 129 on a forming signal 141 to the print engine 130, whereby the image is formed based on that signal. Also, the controller 120 and the printer engine 130 communicate via an interface 142 in various ways.

The printer engine 130 comprises an image forming part 131, an operation part 132, and a control part 133. The image forming part 131 has a function of outputting the image data sent from the host computer 110 onto a recording medium, in color or gray scale, at a resolution of 400 dpi for the image processing apparatus. The control part 133 controls the printer 130 to perform a printing function in accordance with the communication substance between the operation part 132 and the image processing apparatus 120. The operation part 132 is used to make various settings of the printer or instruct various operations.

The controller 120 can communicate via the network interface 121-2 to the device on the network, and communicate not only the print data but also the device control data, device status and management information.

As an example, the consumables information, including toner residual amount, residual number of sheets for every size in every cassette, and residual amount of staples, may be communicated. Also, the status information (door open, paper jam) of the printer, and the presence or absence of mounting various kinds of optional devices (paper ejector (sorter), Z folder, paper deck) may be communicated. The device set values may be also communicated.

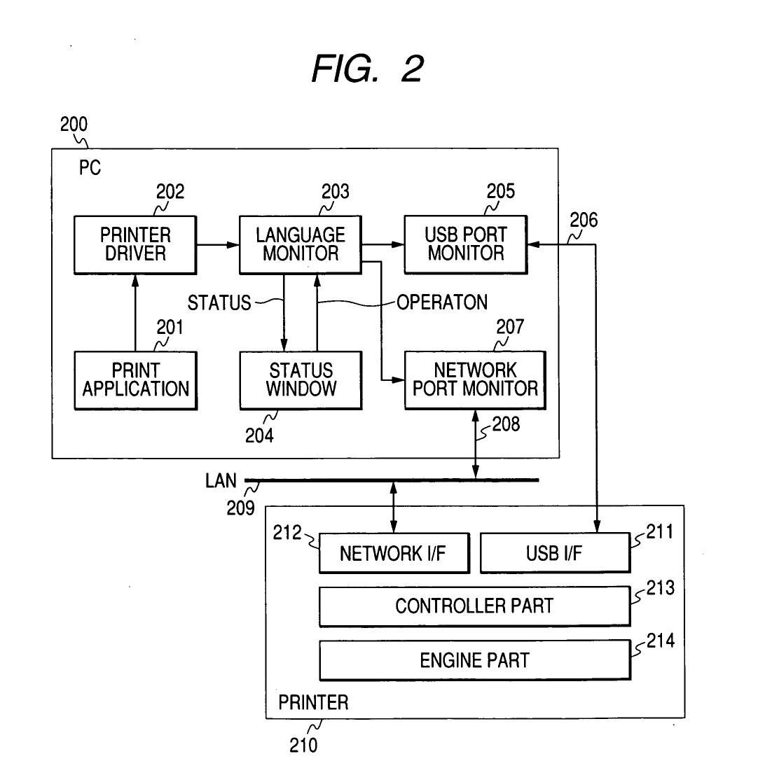

In the forgoing explanation, the image forming apparatus 150 is the type of receiving the PDL data from the host computer, and making the rendering of image and the print control for the image within the printing apparatus, but may be the type of making the rendering of print image and the print control in a PrinterDriver (printer driver) 202 or a LanguageMonitor (language monitor) 203 operating on the host computer 110 as shown in FIG. 2. The configuration of the host computer in this case will be described below.

FIG. 2 is a software block diagram of the host computer in a print control system to carry out the invention. In the host computer 200, an Application (print application) 201 for performing the printing is operating. When a print process is issued, a printer driver 202 installed beforehand is initiated to produce the print image data. The produced print image data is passed to the language monitor 203, which then transfers various kinds of commands for controlling the printing and the produced print image data via a USBPortMonitor (USB port monitor) 205 through a USB cable 206 to a printer 210 in accordance with a prescribed protocol. In the case of the network connection, but not the USB, they are transferred via a network port monitor and a network LAN to the printer 210.

Various kinds of control commands are interpreted and performed by the printer. If it is required to reply to the host computer, a reply process is performed. As an example, there are various kinds of status information in the printing apparatus. This returned status is received through a connection port by the language monitor, whereby the printing process is further performed in accordance with its substance, and the status is notified to a StatusWindow (status window) 204, which then displays the printing situation and the status of the printing apparatus on the host computer.

Also, the status window 204 as shown in FIG. 2 can accept an operation request of the user such as a print suspend or cancel, its request being appropriately conveyed to the language monitor 203. The language monitor 203 transfers a command corresponding to the conveyed operation request via the USB port monitor 205 and the USB cable 206 to the printer 210 in accordance with the prescribed protocol, whereby the controller part performs a process according to the transferred command.

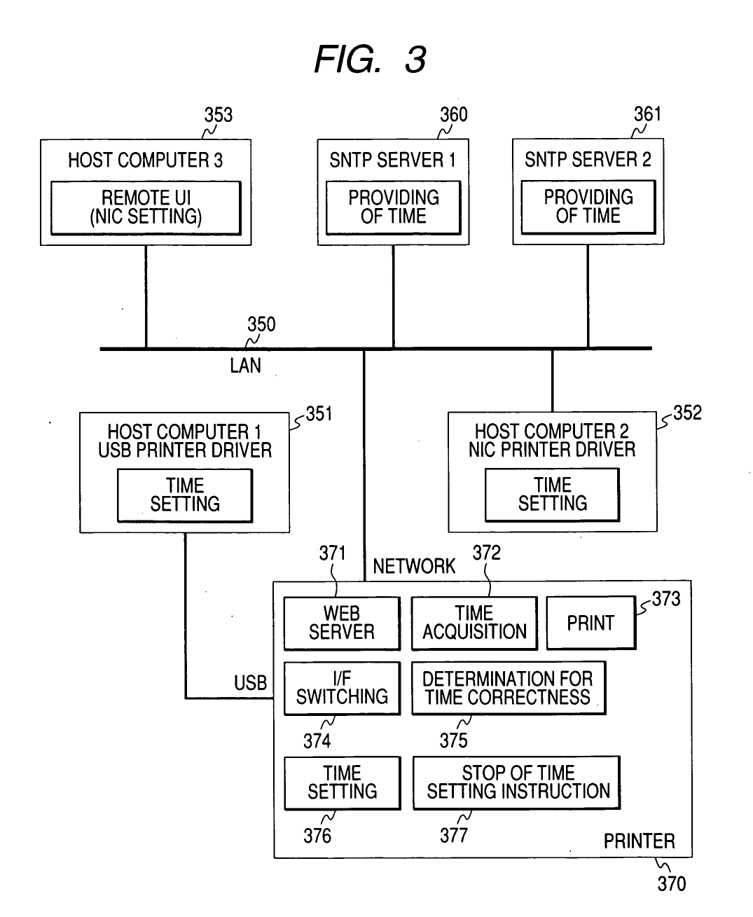

FIG. 3 is a block diagram showing the whole of a print control system that implements the invention. An SNTP server 360/361 for servicing the time information exists on the network. More than one SNTP server may exist. Though the SNTP server exists here, an NTP server may exist. A network printer 370 singly has no clock function. The SNTP server and the network printer 370 communicate to employ the time information acquired from the server as the time information within the printer. On the host computer 3, a Web browser is operable in which a Remote UI utility capable of setting up the printer is performed. Thereby, an SNTP time acquisition function is also set up.

In this setting environment, the printer 370 makes an inquiry for the time to the server and sets the time.

In the case where the SNTP server does not exist on the network, the host computer 1 (351) of local connection or the host computer 2 (352) of network connection may set the time information for the printer 370. In the present situation, the host computer has normally a real time timer to hold the time information.

In the setting environment, the printer does not inquire the time, but the host computer makes a compulsory instruction of setting the time.

The time information of the host computer acquired by receiving a setting instruction on the printer side includes the time and the attribute of time correctness. When a time setting instruction is issued to the printer 370, the time, its the attribute and the host name are included. Time correctness comparison means compares the substance of the time setting instruction received from the host computer and the set substance of the already set time and determines which time should be set up.

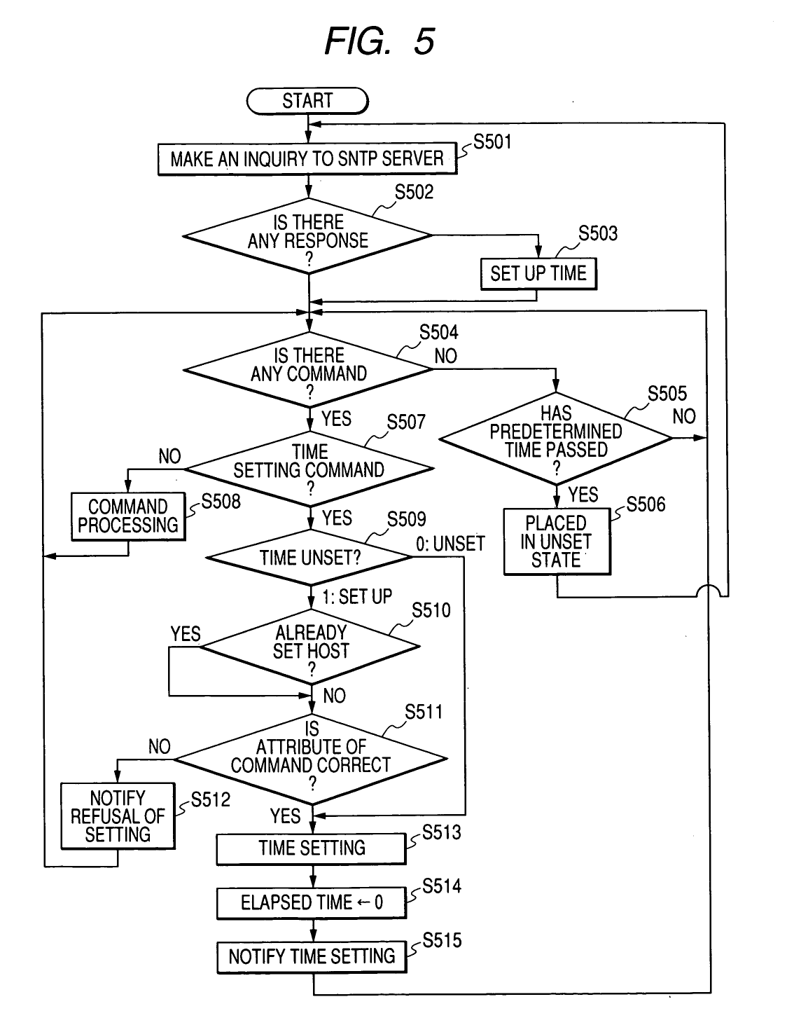

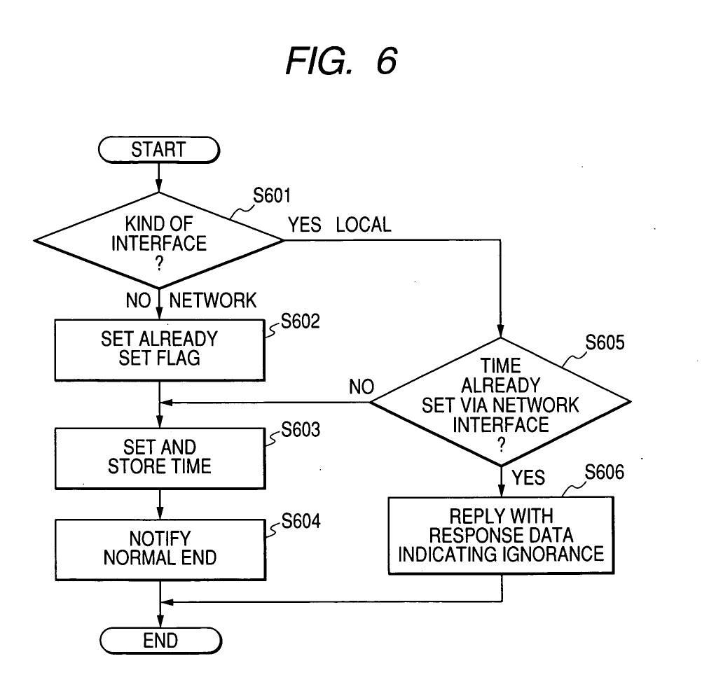

When the time setting instruction from the host computer is accepted (step S513 in FIG. 5, step S603 in FIG. 6), or when the time is acquired from the network time server (step S503 in FIG. 5), the time information including the instruction time and the acquisition time are set as the printer time by time setting means. At this time, various attributes (e.g., host name) of the time are also recorded.

When the time setting instruction from the host computer is not accepted, time setting instruction interrupting means 377 may instruct the time setting instruction means of the host computer not to make the time setting instruction anymore. On the host computer side, the following time setting instruction is not issued by the time setting instruction means, if instructed.

The communicated time information is all GMT. On the time receiving side, the time information is obtained by converting the time in terms of a time difference and calculating the local time.

However, needless to say, the time difference information may be appended to the “time information”.

In this embodiment, the time is communicated in the GMT, and on the time receiving side, the local time is calculated by converting the time in terms of the time difference.

[Operation on the Host Side]

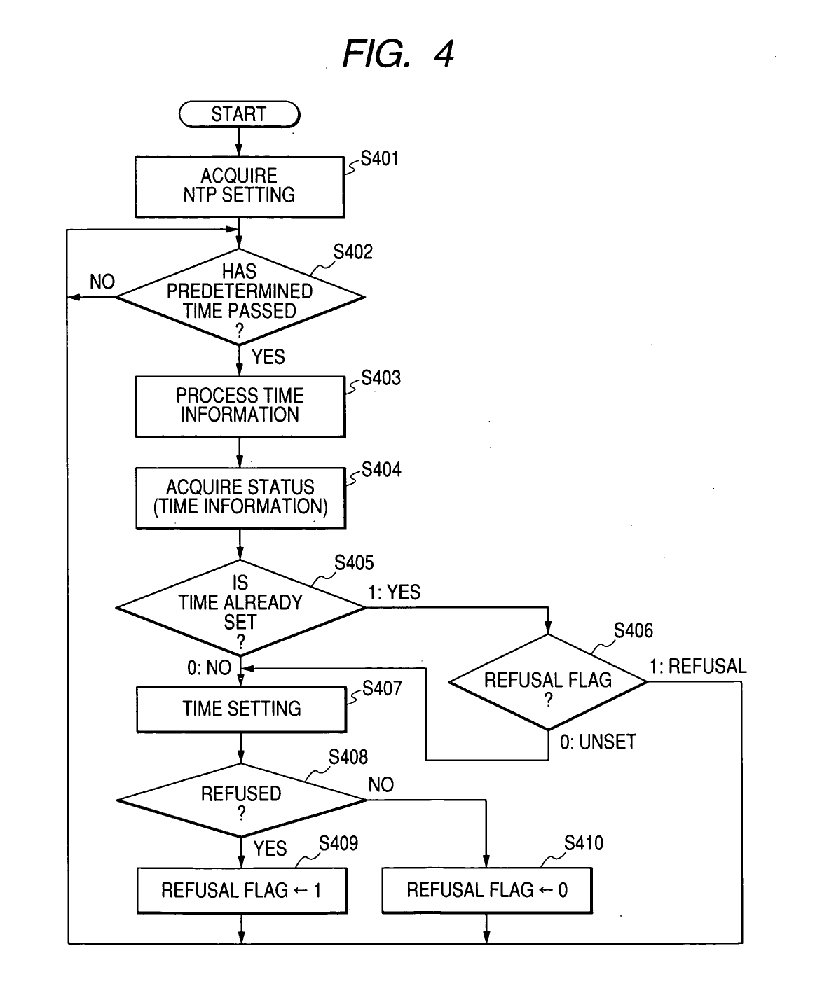

FIG. 4 is a flowchart showing the operation on the host side in this embodiment. The operation on the host side will be described below in detail using to this flowchart. In practice, a transmission program process is performed by the host computer 351 or 352 in FIG. 4.

The flowchart of FIG. 4 is performed when a user setting of whether or not to perform the flowchart of FIG. 4 (transmitting a time setting command to the printer) is made in the PrintDriver (print driver) or the LanguageMonitor (language monitor) on the host side, and the setting is effective to perform the flowchart of FIG. 4. Also, the setting of whether or not to perform the flowchart of FIG. 4 may be referred to by the PrinterDriver (printer driver) or LanguageMonitor (language monitor) itself, when the PrinterDriver (printer driver) or LanguageMonitor (language monitor) is initiated.

The transmission program uses the time information, the attribute of time and the status in a work area. The time information holds the time information of the host, and the initial value is the time when the transmission program is started. Among the attributes of the time, the attributes classified in 1 and 2 and beyond indicate how and via which route the time in the host computer is set up, in which the initial value is 1. The attribute takes the values of 0, 1, and 2 and beyond.

The attribute of 0 indicates the unset time in the printer, and is used as the attribute of the time in the printer. The attribute of 1 indicates the time of using a local real time clock, in other words, the time in the host computer not connected to the network for access to the NTP server. In this embodiment, 2 and beyond indicate the time acquired by an NTP (Network Time Protocol) or an SNTP (Simple Network Time Protocol). The time acquired by the NTP is based on the time acquired by an atomic clock or the GPS, and more accurate than the time acquired from the local real time clock.

Also, the NTP server can transfer the time information to another NTP server. When the time information is transferred, the time is delayed by a transfer processing time, and the originality (correctness) of the time information may be degraded. Hence, this value is incremented by +1 every time the time information is transferred. And the time of any originality is acquired by the host computer or SNTP server. Also, the status holds the time setting information, and the time setting information includes the host name that sets up the time, and the attribute of the time.

First of all, an instance where the time of the printer is autonomously set up from the host side will be described below. If started, the transmission program operating on the host side acquires the time setting method of the host as to whether or not the NTP is set up from the OS at step S401. If it is set up, the attribute of the time is set to 2 or beyond, or if not, the attribute is set to 1.

At step 402, it is judged whether or not a predetermined time has passed in terms of the time of the host computer. This is because the time setting to the device is made at certain intervals.

At step S403, the time information within the host computer is processed for the time setting command. This processing is performed by the PrinterDriver (printer driver) or the LanguageMonitor (language monitor) in FIG. 2. At step S404, a status acquisition command is transmitted to the printer, and as its response, a printer time setting information status (already set flag, refusal flag, etc.) is acquired.

At step S405, it is discriminated whether or not the time attribute of the time setting information of the received status is 0. If it is 0, it is discriminated that the time information is unset, and the procedure goes to step S407, or otherwise, goes to step S406.

At step S406, the value of a time setting refusal flag is evaluated. If it is 0, the procedure goes to step S407, because the time setting is not refused, or if it is 1, the procedure gets back to step S302 to suppress the transmission of the time setting command because the time setting is refused. The default value of the refusal flag stored beforehand in the memory of the host computer is “0”.

At step S407, the time setting command prepared is transmitted via the PrinterDriver (printer driver) 202 and the LanguageMonitor (language monitor) 203 of FIG. 2 to the printer. The time setting command includes the time, the attribute of the time and its host name. Any one of the modules 202 and 203 may issue the time setting command on the host computer side, and is called control software or control means.

At step S408, it is discriminated whether or not the time setting command is refused from the response of the time setting command. If it is refused, the procedure goes to step S409, or if it is accepted, to step S410.

At step S409, the refusal flag is set to 1, and the procedure returns to step S402. At step S410, the refusal flag is set to 0, and the procedure gets back to step S402.

If the time information is not acquired at step S301, the time setting is not made.

[Operation on the Printer Side]

FIG. 5 is a flowchart showing the operation on the printer side in this embodiment. The operation will be described in detail, using this flowchart. In practice, this operation is performed by a control circuit 120 of the printer in FIG. 1 and the printer 370 in FIG. 3.

The control circuit uses the time, the attribute of time, the host name and the elapsed time in a work area. The time holds the set-up time, and the initial value is 0. The attribute of the time indicates the method for acquiring the set-up time. The meaning has been explained in the operation on the host side. The host name holds the host name making the time setting, and no initial value is written. The elapsed time holds the time elapsed since the last time setting, and the initial value is 0. Also, an internal clock measures the elapsed time.

First of all, if the control circuit is initiated, the network time information is inquired to the SNTP server on the network at step S501.

If there is a response to this inquiry at step S502, the time information within the printer device is set using the responded time at step S503.

At step S504, it is discriminated whether or not a command from any one of the host computers is received via any one of the interfaces 211 and 212. If the command is received, the procedure goes to step S507, of if not, to step S505.

At step S505, it is discriminated whether or not the elapsed time is more than the preset time (e.g., one hour). If the preset time has not passed, the procedure gets back to step S504, or if it has passed, proceeds to step S506.

At step S506, there is possibility that the host is down because no time setting instruction is made for a certain period of time. Therefore, the attribute of the time is initialized to 0 of the unset state, enabling the time setting to be accepted from any other external time originator, and the procedure returns to step S501. Herein, the time is set by making an inquiry to the SNTP server again. The processing at steps S505 and S506 is effective especially when the precision of the clock function of the printer is so bad as to shift the time.

At step S507, it is discriminated whether or not the command is the time setting command. In case of the time setting command, the procedure proceeds to step S509, or otherwise, goes to step S508.

At step S508, the relevant command process is performed, and the procedure gets back to step S504.

At step S509, it is discriminated whether or not the attribute of the set-up time is 0. If it is 0, it is discriminated that the attribute is unset, and the procedure goes to step S513. Otherwise, it is discriminated that the attribute is set, and the procedure proceeds to step S510.

At step S510, it is discriminated whether or not the time setting command is from the host name of the currently set time by comparing the host name included in the time setting command received at step S504 and the host name in the work area.

If the host names are matched, it is discriminated that the command is from the currently setting host, and the procedure proceeds to step S511. If unmatched, the procedure goes to step S511 because the setting command is from another host.

At step S511, the attribute (originality) of the time of the time setting command received at step S504 and the attribute (originality) of the currently set time are compared to discriminate which of them is correct. The time discriminated to be correct is considered the time with high priority. That is, the time has higher priority in the order in which the attribute of the command is 2, 2 or beyond, 1 and 0. If the time with high priority is determined, namely, the time indicating more correct attribute is received, the procedure proceeds to step S513.

If it is determined that the currently set time has higher priority, the procedure goes to step S512.

At step S512, the refusal of the time setting command is notified to the host, and the procedure gets back to step S504.

At step S513, the time setting is made based on the time included in the time setting command, in which the host name and attribute of the originator of the time setting command are saved in the work area. Since the time is set at step S411, the elapsed time is reset to 0, and the procedure proceeds to step S515. At step S515, it is notified to the host that the time setting command is accepted, and the procedure gets back to step S504.

In accordance with the flowchart of FIG. 5 as described above, in the printer that can communicate with the external host computer, the priority of the time inputted from each of a plurality of time originators 110 to 113 of FIG. 1 is determined at step S511, and the time determined to have higher priority is set at step S513, whereby it is possible to set more correct time in the printer main body. Also, even if any device is in a state of issuing no time setting command due to some causes, such as power off, the time is set based on the time setting command from any other time originator.

Herein, the time originator, for example, may be another device like those 110 to 113 of FIG. 1, or another software module such as the SNTP server function or Language Monitor 203 within the same device.

Though the flowchart of FIG. 5 is described with the interfaces 211 and 212 in FIG. 2, it is not limited thereto. For example, the interface 211 may be excluded, and the priority of the time from each of the plurality of time originators inputted into the network interface 212 may be determined, thereby performing the time setting process.

Reference is made to FIG. 6. FIG. 6, like FIG. 5, is another example showing the operation for the time setting command in the print controller. At step S601, the kind of interface through which the time setting command is received is determined. If the time setting command is received through the local interface, the procedure goes to step S605, or if it is received through the network interface, proceeds to step S602.

A determination process at step S601 may be made by including the attribute of the time in the time setting command and determining this attribute in the same manner as step S511. In this case, the time setting command may include the attribute of 1 for the local interface or the attribute of 2 or 2 and beyond for the network interface in accordance with the kind of interface used for data communication in the host computer of originator of the time setting command.

Turning back to FIG. 6, at step S602, an already set flag indicating that the time setting command is received through the network interface is set up. This flag is cleared immediately after the power is turned on. That is, the flag, once set, is invalid, if the power is turned off.

At step S603 following step S602, the time notified with the time setting command is stored in an allocated area on the RAM. Finally, at step S604, a response command indicating that the time is normally set is returned to the command originator, and the time setting command process is ended.

On the other hand, if the time setting command is received through the local interface, the already set flag stored in the RAM at step S605 is checked. If the already set flag is not set, namely, if the time setting command is not received through the network interface, the procedure goes to step S603 to perform the time setting process. On the other hand, if the already set flag is set, namely, if the time setting command is already received through the network interface, the time setting command from the local PC is ignored and the procedure goes to step S606, where the response data indicating ignorance is returned to the command originator. Thereby, the time setting command process is ended.

In the flowchart of FIG. 6, the priority of the time is determined based on the kind of interface into which the time setting commands from a plurality of time originators are inputted, whereby the more correct time setting through the network can be effected. Even if the time setting through the network can not be made, the time setting process may be made based on the time setting command inputted through the local interface such as USB interface.

With the image forming apparatus according to this embodiment of the invention as described above, of the time setting commands from the local host computer, the time setting command through the network interface is preferentially dealt with in the controller part, whereby the time information of high reliability can be held within the printer.

In the actual network environment, the time is periodically acquired from the host computer. Only if the time service is not provided because the host computer is abnormal, the time is inquired to another host computer, to which the invention is also applicable.

Only one time information that the printer driver acquires from the outside is saved in this embodiment. However, there are multiple functional parts needing the time information, the time information for use may be preferably controlled for each function.

As an example, there are a device error log and a job log.

For the error log of device, the network time is stored in its log contents. Because the log is created in an error occurrence event for the device simplex.

For the job log, opposed to the error log, the operation time (creation time of the job) of the host computer generating the job and the print time of the job are stored in the log. That is, the job log is not configured only by time within the printer device. The creation time of this job is recorded in the job, and the log is created by its information.

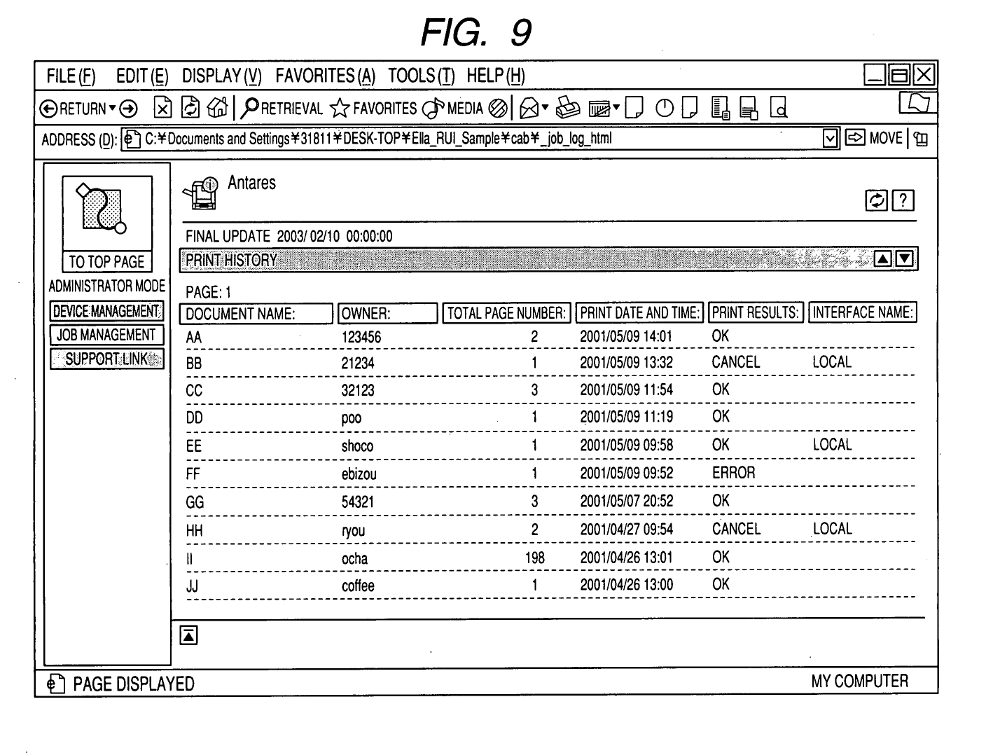

FIG. 9 is an example of displaying the job log in a utility operating on the host PC. In this example, an item of “print date” indicates the creation time of the job. In this example, the print time of the job is not displayed, but held as the log contents.

Though the time information of “final update” is displayed in FIG. 9, this time information is displayed using the time information of the host PC on which the utility is operating (example of this utility is a Web browser, in which the displayed contents of the Web are produced by a network interface card.)

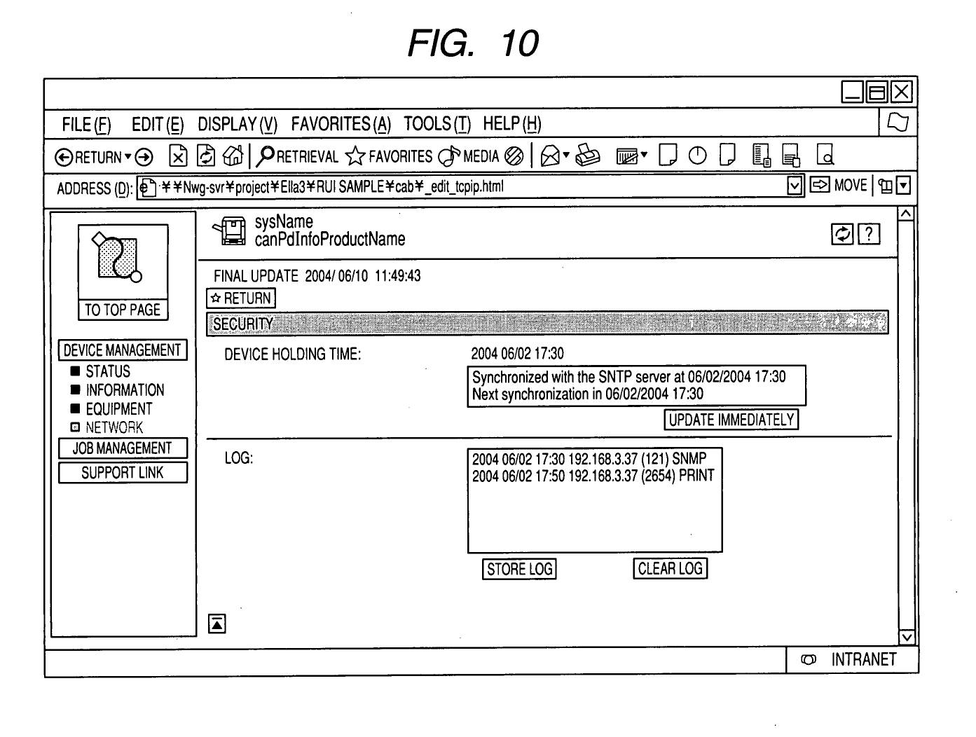

FIG. 10 is another functional screen in the same utility as in FIG. 9, in which the time within the network interface card is displayed and a user interface for making an inquiry to the SNTP server on the network is provided.

It is the time information held in the network interface that is displayed in the “device held time”. And by pressing a “update at once” button, it is possible to remotely issue an instruction of enabling the printer to make an inquiry for the time to the server on the network. The log of the access is displayed on a list box thereon.

The time displayed in the “final update” at the top is the time of the host PC.

When the time information is acquired from the server by pressing the “update at once” button, needless to say, the time is notified to the print device.

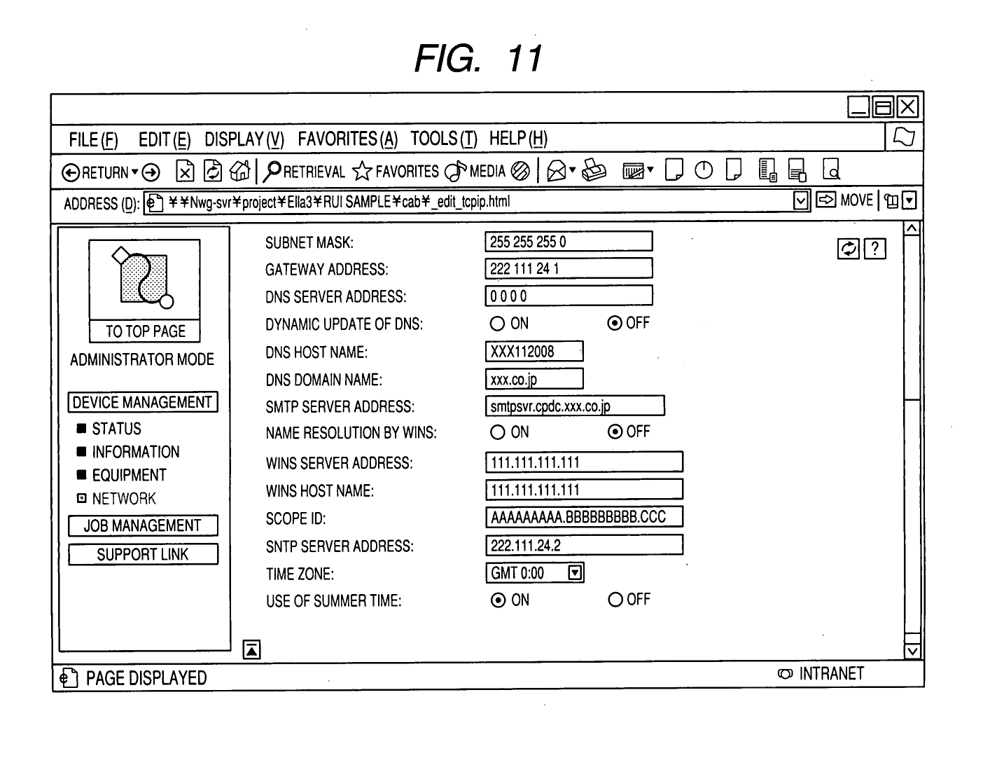

FIG. 11 is another functional screen in the same utility as in FIG. 9, in which a user interface for designating the SNTP server on the network is provided.

Only one SNTP address can be set. Since the time received from the server is the GMT, the time zone and the summer time can be set up as the setting information for calculating the local time. Multiple addresses may be assigned to the server. Also, the time may be inquired by broadcasting.

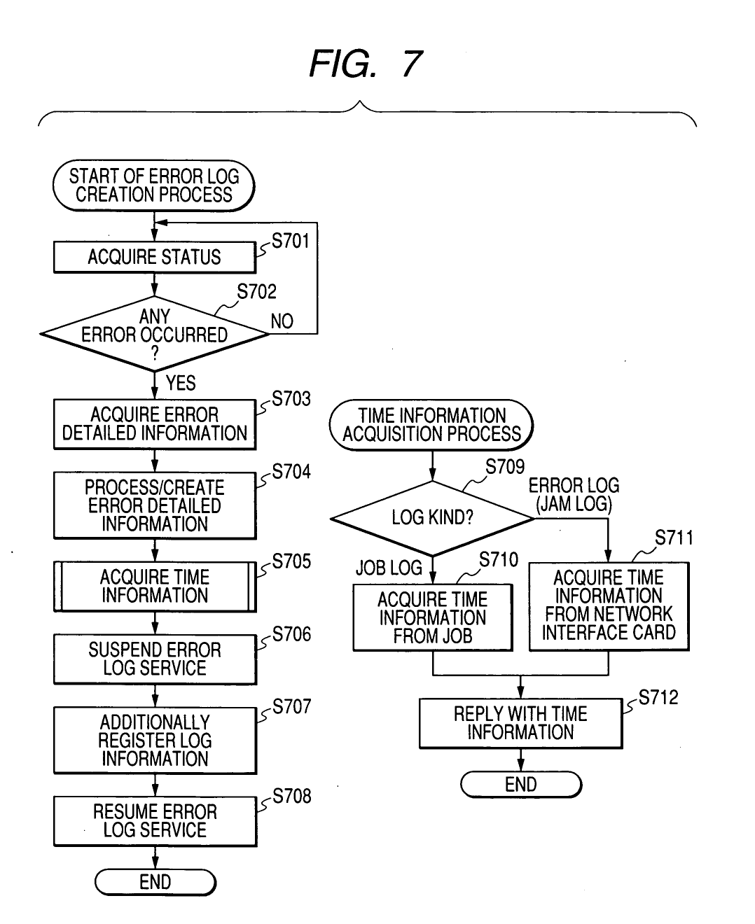

Referring to a flowchart of FIG. 7, the creation of error log that is an example of the use form of the time set up in the flowcharts of FIGS. 5 and 6 as described above will be described below.

First of all, at step S701, the status information of the printer device is acquired. Then, an error state is detected based on its information (step S702).

If the error state is detected, the error detailed information is acquired from the device side (step S703).

And the status information (status code) substance and the error detailed information are processed to produce the information required for the error log (jam log included in the error log) (step S704).

At this time, the time information for use is acquired (step S705). In this case, because of the jam log, the time within the network I/F (the time set up at step S513 or step S603) is acquired and recorded on the log at step S711. And the service of error log is suspended (step S706), and the newly created log information is additionally registered into the database of error log (step S707). Finally, the service of error log is resumed (step S708).

Though the above explanation is made in the case of error log, when the jam state is detected by determining the substance of status code, the jam log may be created. This jam log may be also created based on the time information within the network I/F.

Also, when the job end state is detected, the job log is created. In the case of the job log as previously described, the time information of the log contents is the job creation time included in the job.

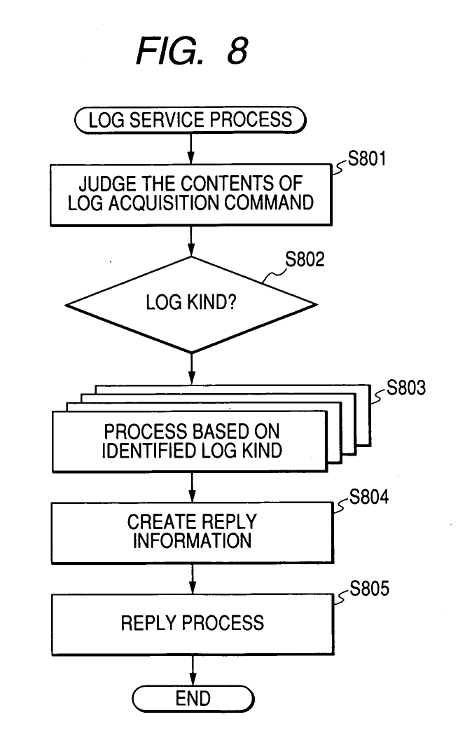

Referring to FIG. 8, a log acquisition command process (log service process) will be described below. This process corresponds to the process where the log created in FIG. 7 is notified to the external host computer.

First of all, the substance of the log acquisition command is judged (step S801).

Since the log functions has plural kinds of log, it is determined to which log access is made (step S802), and the process is subsequently performed for the designated log (step S802 and beyond). The log acquisition command includes the detailed information for access, such as number designation in the log, whereby the relevant log information is drawn out of the database for log in accordance with its information (step S802). The necessary information is further processed from the relevant log information to create the information required for reply (step S803). And the created reply information is returned to a functional part requesting the log acquisition command process (step S804).

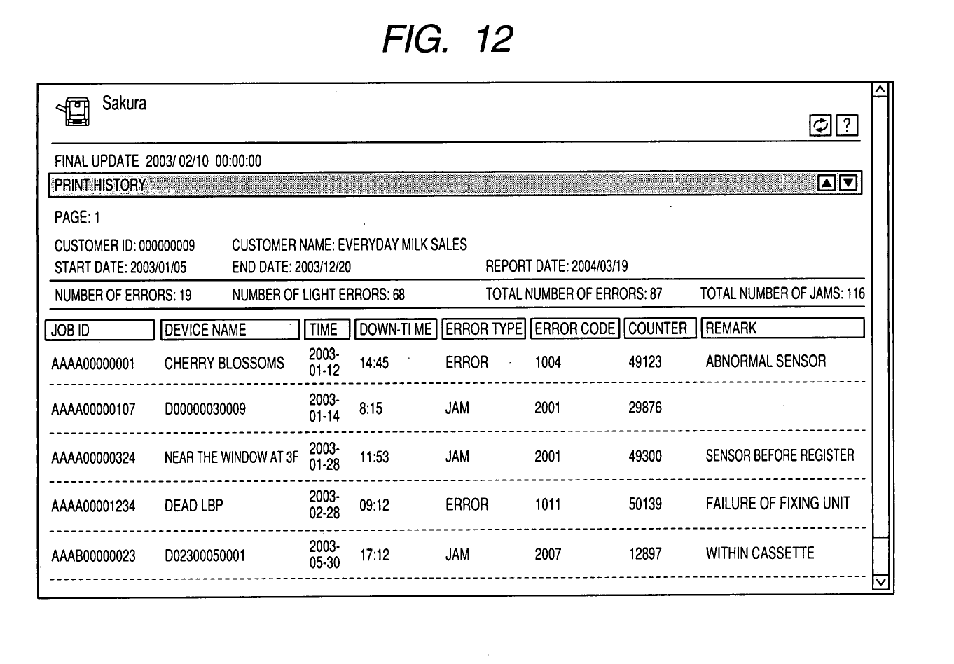

FIG. 12 is an example of the error log, in which the error log contents are displayed by the utility on the host acquiring the log using the log service process.

As previously described, the time in the data of one item of this error log is the time within the network I/F.

An object of the invention may be achieved in such a manner that a recording medium recording the program code of the software for implementing the functions of this embodiment is supplied to a system or an apparatus, and a computer (or CPU or MPU) in the system or the apparatus reads and execute the program code stored in the recording medium. In this case, the program code itself read from the recording medium may implement new functions of the invention, whereby the recording medium recording the program code and the program constitute this invention.

The recording medium for supplying the program code may be a flexible disk, a hard disk, an optical disk, an optical magnetic disk, a CD-ROM, a CD-R, a magnetic disk, a non-volatile memory card or a ROM.

Also, the functions of this embodiment may be implemented not only by executing the program code read by the computer, but also by an OS (operating system) operating on the computer performing a part or all of the processing in accordance with an instruction of the program code.

Moreover, the program code read from the recording medium is written into a memory provided in a function extension board inserted into the computer or a function extension unit connected to the computer, and then the CPU provided in the function extension board or function extension unit performs a part or all of the actual processing in accordance with an instruction of the program code, whereby the functions of this embodiment may be implemented.

This application claims priority from Japanese Patent Application No. 2004-203397 filed Jul. 9, 2004, which is hereby incorporated by reference herein.

What is claimed is:

1. A printer for performing the printing based on the print data from an external host computer, said printer being communicable with the host computer, comprising:
an input interface unit adapted to input time information from each of a plurality of time originators;
a determination unit adapted to make a determination whether or not the time based on the time information inputted via said input interface unit is preferentially set up; and
a setting unit adapted to set the time based on the input time information in accordance with the determination by said determination unit.

2. The printer according to claim 1, wherein said determination unit makes the determination in accordance with a kind of interface for an input source of the input time.

3. The printer according to claim 1, wherein the time information includes a time setting command, and said determination unit determines the priority by comparing an attribute included in the input time setting command and an attribute of the currently set time.

4. The printer according to claim 1, wherein the attribute of the time information inputted via the network has a higher priority than the attribute of the time information transmitted via the local cable.

5. The printer according to claim 1, wherein said setting unit places the set time in an unset state, when there is no input of the time information from the outside for a certain period of time, and said setting unit sets the time based on the time information that is thereafter inputted from any of the time originators.

6. The printer according to claim 1, further comprising a notification unit adapted to make a refusal notification of the time setting to the external host computer, wherein the host computer is controlled to transmit the time setting command to the printer upon receiving the refusal notification.

7. The printer according to claim 1, wherein said input interface unit inputs the time information via the network and/or local cable.

8. The printer according to claim 1, wherein said determination unit makes a determination based on the originality of the time information.

9. A print control apparatus that can communicate with an external host computer, comprising:
an input interface unit adapted to input time information from each of a plurality of time originators;
a determination unit adapted to make a determination whether or not the time based on the time information inputted via said input interface unit is preferentially set up; and
a setting unit adapted to set the time based on the input time information in accordance with the determination made by said determination unit.

10. A control method for use with a printer for performing printing based on print data from an external host computer, the printer being communicable with the host computer, said method comprising:
inputting time information from each of a plurality of time originators;
determining whether or not the time based on the input time information is preferentially set up; and
setting the time based on the input time information in accordance with a determination made in said determining step.

11. The control method according to claim 10, wherein said determining step makes the determination in accordance with a kind of interface for an input source of the input time.

12. The control method according to claim 10, wherein the time information includes a time setting command, and said determining step comprises determining the priority by comparing an attribute included in the input time setting command and an attribute of the currently set time.

13. The control method according to claim 10, wherein the attribute of the time information inputted via the network has a higher priority than the attribute of the time information transmitted via the local cable.

14. The control method according to claim 10, further comprising an initialization step of initializing the set time into an unset state, when there is no input of the time information from the outside for a certain period of time, and a second setting step of setting the time based on the time information that is inputted from any of the plurality of time originators after the initialization in said initialization step.

15. The control method according to claim 10, further comprising a notification step of making a refusal notification of the time setting to the external host computer, wherein the host computer is controlled to transmit the time setting command to the printer upon receiving the refusal notification.

16. The control method according to claim 10, wherein said inputting step comprises inputting the time information via the network and/or local cable.

17. The control method according to claim 8, wherein said determining step makes the determination based on the originality of the time information.

18. A program stored on a computer-readable storage medium such that, when executed by a computer, the program causes the computer to execute a control method for use with a printer for performing printing based on print data from an external host computer, the printer being communicable with the host computer, the method comprising:
inputting time information via a network and a local cable from each of a plurality of time originators;
determining whether or not the time based on the input time information is preferentially set up; and
setting the time based on the input time information in accordance with a determination made in said determining step.
